(19) United States
(12) Patent Application Publication
(10) Pub. No.: US 2018/0241580 A1
(43) Pub. Date: Aug. 23, 2018

(54) METHOD AND APPARATUS FOR SPONTANEOUSLY INITIATING REAL-TIME INTERACTIVE GROUPS ON NETWORK

(71) Applicants: SENG-FENG CHEN, TAIPEI CITY (TW); HSIN-TZU CHEN, TAIPEI CITY (TW)

(72) Inventors: SENG-FENG CHEN, TAIPEI CITY (TW); HSIN-TZU CHEN, TAIPEI CITY (TW)

(21) Appl. No.: 15/894,008

(22) Filed: Feb. 12, 2018

(30) Foreign Application Priority Data
Feb. 18, 2017 (TW) 106105492

(51) Int. Cl. H04L 12/18; H04L 12/58

(52) U.S. Cl. CPC H04L 12/1818; H04L 51/10

(57) ABSTRACT

A method and apparatus are disclosed for spontaneously initiating real-time interactive groups on the network executed on a host. In one embodiment, the method includes at least one initiator terminal sending a theme message of chat invitation. The method further includes sending said theme message of chat invitation to at least one potential participant terminal. The method also includes said at least one potential participant terminal accepting said theme message of chat invitation to become at least one participant terminal, and to form an interactive group, wherein said interactive group includes said at least one initiator terminal and said at least one participant terminal.

### FIELD OF THE INVENTION

The present invention relates generally to a method for initiating interactive groups on the network, and particularly to a method for spontaneously initiating real-time interactive groups on the network.

### BACKGROUND OF THE INVENTION

As the Internet is becoming popular and ubiquitous, social networking sites and online chat rooms become prosperous accordingly. They are almost indispensable parts of people's daily lives. Among current social networking sites, Facebook is the most popular. It mainly provides users with the function of communicating and connecting with their friends and acquaintances. In addition, Facebook also includes Explore Nearby Places and Near Friends. The former provides the location information nearby a user while the latter provides a list of the friends nearby a user and their location information. Unfortunately, Facebook does not provide the information of the nearby unacquainted Facebook users for a user. In other words, Facebook does not provide the real-time interactive function for a user to know the other near Facebook users.

Besides, the friending pattern in current online chat rooms, such as BeeTalk, is mainly focused on heterosexual friending. In such sites, the members who expect friending and chatting need to provide their ages, gender, and photos as the references for chatting or friending. Nonetheless, such a friending method is time consuming and the hit rate is low. In addition, BeeTalk provides a function like a radar for searching the other online friends on the site. Unfortunately, users cannot configure the radar function. For example, the searching range or criteria cannot be set. When the other friends are searched using the radar function, BeeTalk provides only the personal information to a user for reference; the user, likewise, cannot find the chat targets having common points with the user immediately. Accordingly, BeeTalk does not allow prompt interaction for further chats.

Moreover, current online chat rooms, such as WeChat and Line, provide the function of searching nearby strangers for friending or chatting by shaking smartphones. Taking WeChat for example, a user may shake his smartphone to transmit a certain signal for connecting to another use shaking his smartphone concurrently. Then they both may be connected and added as friends. In Line, the function is similar. Line users may shake their smartphone by asking nearby other users for adding as a friend. In such APPs, although a user may transmit friending signals to nearby indefinite people, there might be no any common point, for example, common topics or types, between the signal transmitter and receiver because the transmitted friending signal is random. Consequently, this function is seldom used by APP users.

BBM online chat room, just like most online chat rooms, the targets of the sent messages are limited to the existing friends of a user but not the others.

Familonet website provides a user with the function of locating his family members and friends. CircleMe is a website for sharing travel experiences. Banjo provides a user with the function of sharing the dynamic information around the user using GPS. Firefly enables a user to search if his friends are nearby.

In addition, some current websites provide live streaming; people can publish their stories real-timely anytime and anywhere. Such live streaming can initiate real-time interaction on the network. Nonetheless, live streamers do not send meaning invitation messages to the other people on the network. Thereby, the viewers of live streams participate randomly, or they must know the live streaming time. The views do not know the content in advance. They need to view the live stream for a while before they can decide if they are interested in the content. If not, they will stop watching. In this way, if people want to watch the live streams of interesting topics and further interact and chat with the streamers, they need to search live-streaming sites and watch the streaming content for a period of time before they may be sure if the live-streaming contents are their interesting subjects. This process is quite time consuming.

To sum up, current chatting and friending websites mostly provide connecting and sharing functions to existing acquaintances. Alternatively, they enable users to browse the basic information of other users and search possible chat targets having common points. Then, users may send an invitation or notification for friending. This kind of websites or APPs does not allow real-time searching of the targets having common points, making the function of interactive groups with real-time initialization not possible.

In one embodiment, the present invention generally provides a method for spontaneously initiating real-time interactive groups on the network for solving the above drawbacks in the prior art. The method according to one embodiment of the present invention is real time, open (for all other online users), topic oriented, categorized (in chat groups, including subject and identity), and location oriented.

### SUMMARY

An objective of one embodiment of the present invention is to provide a method for spontaneously initiating real-time interactive groups on the network. The method enables spontaneous searching chat targets having common topics for solving the problem of inability in initiating interactive groups spontaneously in current social networking or friending sites.

Another objective of one embodiment of the present invention is to provide a method for spontaneously initiating real-time interactive groups on the network. According to the method, an initiator terminal could send a theme message of chat invitation to at least one potential participant terminal having several common points with the initiator terminal. Then, an interactive group may be easily initiated to start interactions.

In one embodiment, the present invention discloses a method for spontaneously initiating real-time interactive groups on the network. The method could be executed on a host and comprises steps of: at least one initiator terminal sending a theme message of chat invitation; sending the theme message of chat invitation to at least one potential participant terminal; and the at least one potential participant terminal accepting the theme message of chat invitation, becoming at least one participant terminal, and forming an interactive group. The interactive group could include the at least one initiator terminal and the at least one participant terminal.

To sum up, the method for spontaneously initiating real-time interactive groups on the network according to one embodiment of the present invention could enable an initiator terminal to send a theme message of chat invitation to potential participant terminals. The theme message of chat invitation is the subject or topic by which the initiator terminal expects to interact. Furthermore, the initiator terminal may even search targets of interested generation, community, or identity. Then an interactive group may be formed with the targets for further interacting and friending.

### BRIEF DESCRIPTION OF THE DRAWINGS

FIG. 1 shows a flowchart according to an exemplary embodiment of the present invention;

FIG. 2 shows a block diagram of the architecture according to an exemplary embodiment of the present invention;

FIG. 3 shows a diagram of the message page of a potential participant terminal according to an exemplary embodiment of the present invention;

FIG. 4 shows a diagram of the positioning page of an initiator terminal according to an exemplary embodiment of the present invention;

FIG. 5 shows a diagram of the positioning page of a potential participant terminal according to an exemplary embodiment of the present invention;

FIG. 6 shows a diagram of the category setting page of a potential participant terminal according to an exemplary embodiment of the present invention;

FIG. 7 shows a diagram of the attribute setting page of a potential participant terminal according to an exemplary embodiment of the present invention;

FIG. 8A and FIG. 8B show flowcharts of initiating interactive groups according to an exemplary embodiment of the present invention; and

FIG. 9 shows a flowchart of initiating exclusive interactive groups according to an exemplary embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

In the specifications and subsequent claims, certain words are used for representing specific devices. A person having ordinary skill in the art should know that hardware manufacturers might use different nouns to call the same device. In the specifications and subsequent claims, the differences in names are not used for distinguishing devices. Instead, the differences in functions are the guidelines for distinguishing. In the whole specifications and subsequent claims, the word “comprising” is an open language and should be explained as “comprising but not limited to”. Besides, the word “couple” includes any direct and indirect electrical connection. Thereby, if the description is that a first device is coupled to a second device, it means that the first device is connected electrically to the second device directly, or the first device is connected electrically to the second device via other device or connecting means indirectly.

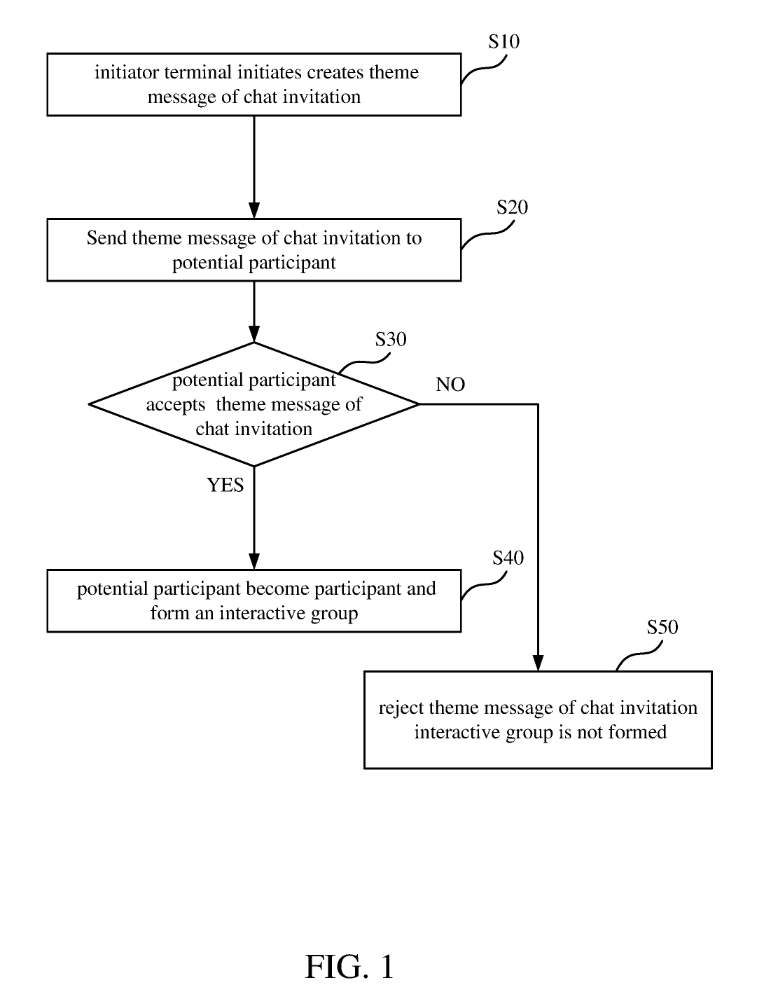

FIG. 1 shows a flowchart according to an exemplary embodiment of the present invention. In one embodiment, the present invention discloses a method for spontaneously initiating real-time interactive groups on the network. The method could be executed on a host and comprises the following steps:
Step S10: At least one initiator terminal creates a theme message of chat invitation;
Step S20: Send the theme message of chat invitation to at least one potential participant terminal;
Step S30: Confirming if the potential participant terminal accepts the theme message of chat invitation;
Step S40: The potential participant terminal accepts the theme message of chat invitation and becomes a participant terminal, and forms an interactive group with the initiator terminal; and
Step S50: The potential participant terminal does not accept the theme message of chat invitation and an interactive group is not formed.

The above host may be a computer or a server and provides an interactive platform. The above initiator terminal and potential participant terminal may be a smart electronic device, for example, a smartphone or a tablet computer. The initiator terminal and the potential participant terminal include network function and connect to the host via networks for logging in the interactive platform. According to the step S10, when at least one user expects to establish interaction relationship, for example, chatting or inviting, with other users, the user may log in the host via a smart electronic device for logging in the interactive platform and create a theme message of chat invitation. In other words, the initiator terminal sends a theme message of chat invitation. The smart electronic device creating the theme message of chat invitation is the initiator terminal. The theme message of chat invitation may be a text message or a non-text message. The number of words in a text message is preferably within, but not limited to, 20. If the theme message of chat invitation is the non-text message, the theme message of chat invitation may be an embedded live stream, a general video clip, or a photo. Instead of a general greeting message, the theme message of chat invitation created by the initiator terminal could include a theme. This theme message of chat invitation will be sent to the host.

Next, in step S20, the host sends the theme message of chat invitation created by the initiator terminal to the indefinite smart electronic devices logged on the interactive platform. The smart electronic devices receiving the theme message of chat invitation are potential participant terminals. Thereby, the users of the potential participant terminals may view the content of the theme message of chat invitation.

As shown in the step S30, after the users of the potential participant terminals view the content of the theme message of chat invitation, they may decide whether to accept the theme message of chat invitation via the potential participant terminals. That is to say, they may decide whether to accept the invitation from the initiator terminal. As a potential participant terminal accepts the theme message of chat invitation, as shown in the step S40, the potential participant terminal becomes a participant terminal. Then the initiator terminal and the participant terminal may form an interactive group, such as a chat group or a common activity group. The initiator terminal and the participant terminal may chat or perform common activities in the interactive group. According to the above description, the interactive group includes at least one initiator terminal and at least one participant terminal.

When a potential participant terminal does not accept the theme message of chat invitation, as shown in step S50, the potential participant terminal rejects the theme message of chat invitation. Then the initiator terminal and the participant terminal do not form an interactive group. In addition, the potential participant terminal will hide the theme message of chat invitation. The above initiator terminal, potential participant terminal, theme message of chat invitation, participant terminal, and the interactive group will be described subsequently.

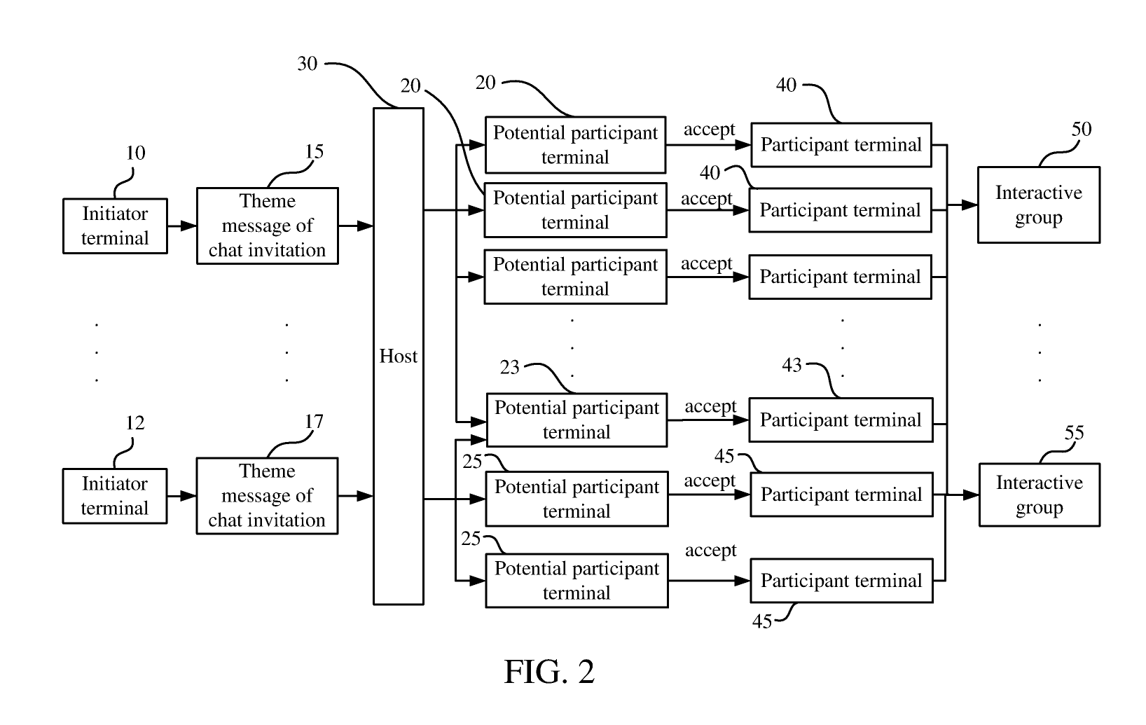

Please refer to FIG. 2, which shows a block diagram of the architecture according to an exemplary embodiment of the present invention. As shown in FIG. 2, at least one initiator terminal 10, 12 are connected to a host 30 via the network. In one embodiment, the initiator terminal 10 creates a theme message of chat invitation 15; and the initiator terminal 12 creates a theme message of chat invitation 17. The initiator terminals 10, 12 send the theme messages of chat invitation 15, 17 to the host 30, respectively. The host 30 sends the theme message of chat invitation 15 to at least one indefinite potential participant terminal 20 on the interactive platform; the host 30 sends the theme message of chat invitation 17 to at least one indefinite potential participant terminal 23 on the interactive platform. The at least one potential participant terminal 20 may accept the theme message of chat invitation 15 and become a participant terminal 40. Thereby, the initiator terminal 10 and the participant terminal 40 form an interactive group 50 on the interactive platform. Likewise, at least one potential participant terminal 25 may accept the theme message of chat invitation 17 and become a participant terminal 45. Thereby, the initiator terminal 12 and the participant terminal 45 form an interactive group 55 on the interactive platform.

Besides, the host 30 may also send the theme message of chat invitation 15 created by the initiator terminal 10 to the potential participant terminal 23. In other words, the potential participant terminal 23 may receive the theme messages of chat invitation 15, 17 of the initiator terminals 10, 12 concurrently. According to one embodiment, the potential participant terminal 23 accepts the theme message of chat invitation 15 of the initiator terminal 10 and becomes a participant terminal 43. Thereby, the participant terminal 43 and the initiator terminal 10 form the interactive group 50. Then the interactive group 50 could include the initiator terminal 10 and the participant terminals 40, 43. In particular, the theme message of chat invitation 12 according to the present invention refers to invitation message asking for concrete replies for chats, discussions, or responses. Namely, the chat according to the present invention refers to general chats or discussions but not limited to informal chats.

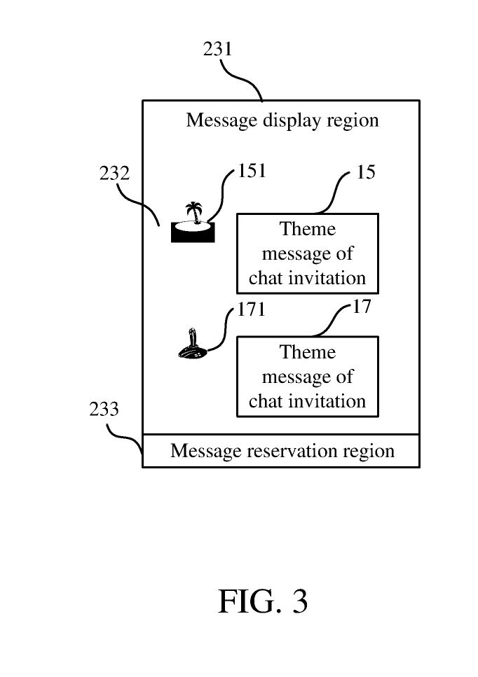

Please refer to FIG. 3, which shows a diagram of the message page of a potential participant terminal according to an exemplary embodiment of the present invention. In FIG. 3, the message page of the potential participant terminal 23 shown in FIG. 2 is taken for example. As shown in FIG. 3, the potential participant terminal 23 includes a message page 231, which contains a message display region 232 and a message reservation region 233. Multiple theme messages of chat invitation 15, 17 received by the potential participant terminal 23 may be displayed in the message display region 232 of the message page 231 concurrently. The theme messages of chat invitation 15, 17 may be displayed in the message display region 232 according to a specific order or randomly. The specific order may be, for example, the time when the potential participant terminal 23 receives the theme messages of chat invitation 15, 17, or the categories of the theme messages of chat invitation. For example, the preset order of category may be travel, e-gaming, and news.

Please refer again to FIG. 3. When the potential participant terminal 23 receives the plurality of theme messages of chat invitation 15, 17, initially, the message display region 232 of the message page 231 displays a plurality of symbols 151, 171, instead of the content of the plurality of theme messages of chat invitation 15, 17, for simplifying users' visual perception on the message page 231. The plurality of symbols 151, 171 represent the theme messages of chat invitation 15, 17, respectively. When a user selects the plurality of symbols 151, 171, the content of the plurality of theme message of chat invitation 151, 171 appear in the message display region 232 of the message page 231. Besides, after the plurality of theme messages of chat invitation 15, 17 are displayed in the message display region 232 of the message page 231 for a period, for example, 3 to 8 seconds, the plurality of theme messages of chat invitation 15, 17 may disappear from the message display region 232 while the plurality of theme messages of chat invitation 15, 17 are reserved in the message reservation region 233. When the user selects the message reservation region 233, the plurality of theme messages of chat invitation 15, 17 reserved in the message reservation region 233 may be browsed.

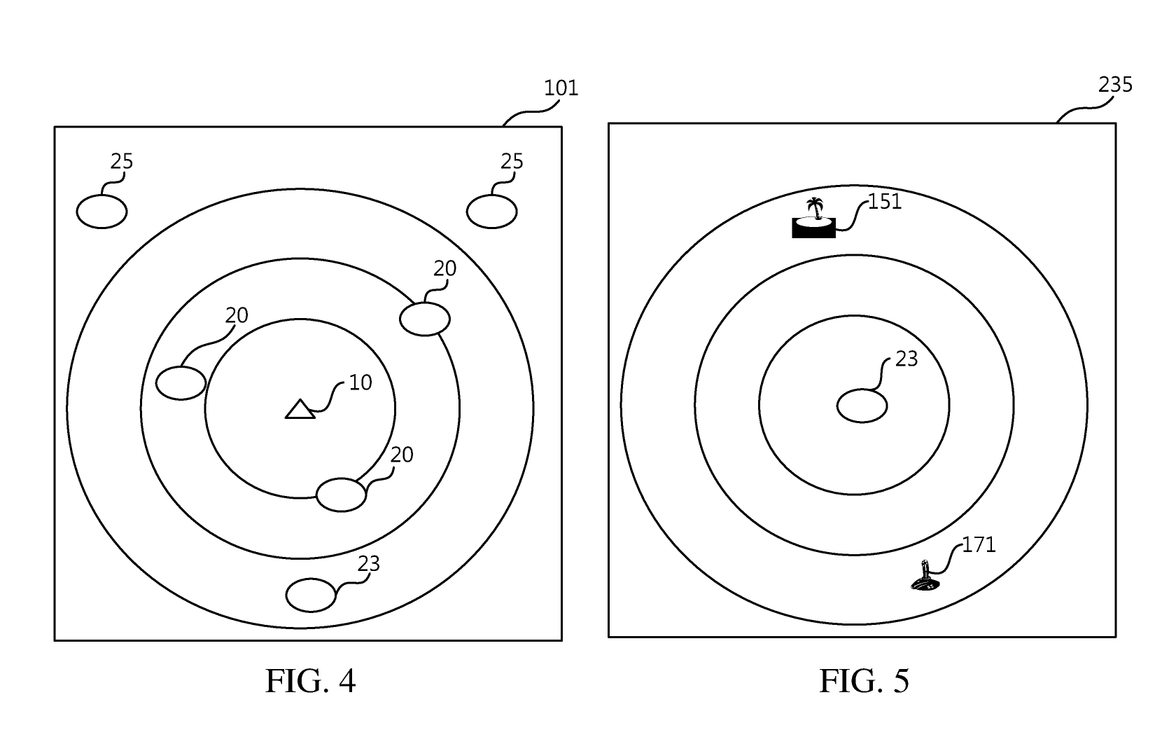

Please refer to FIG. 4, which shows a diagram of the positioning page of an initiator terminal according to an exemplary embodiment of the present invention. The initiator terminal 10 according to the present invention may work with a GPS system to position the location of the initiator terminal 10 and set a limiting distance. As shown in the positioning page 101 of the initiator terminal 10, according to the limiting distance and by setting his location as the center, the initiator terminal 10 sends the theme message of chat invitation 15 to the potential participant terminals within the limiting distance via the host 30. For example, the theme message of chat invitation 15 may be sent to the potential participant terminals within 1 kilometer or with the range between 300 meters and 5 kilometers from the initiator terminal 10. Thereby, it is convenient for the initiator terminal 10 to specify the expected chat targets and thus achieving the purpose of friending.

As shown in FIG. 4, the distances between the potential participant terminals 20, 23 and the initiator terminal 10 are within the limiting distance, hence the theme message of chat invitation 15 of the initiator terminal 10 will be sent to the potential participant terminals 20, 23. On the contrary, the distance between the potential participant terminal 25 and the initiator terminal 10 is beyond the limiting distance, hence the theme message of chat invitation 15 of the initiator terminal 10 will not be sent to the potential participant terminals 25. In addition, according to the limiting distance and by setting his location as the center, the initiator terminal 10 may instead send the theme message of chat invitation 15 to the potential participant terminals beyond the limiting distance via the host 30. For example, the theme message of chat invitation 15 may be sent to the potent participant terminal 25, instead of the potential participant terminals 20, 23.

As described above, the initiator terminal 10 may work with the GPS function to set the range for sending the theme message of chat invitation 15. Namely, the geographical range for sending the theme message of chat invitation 15 is limited, which is beneficial for the initiator terminal 10 to focus on nearby events or subjects, and the initiator terminal 10 may find the potential participant terminals 20, 23 having the common topics based on the nearby events or subjects.

On the other hand, when the initiator terminal 10 needs help, no matter concrete assistance or spiritual consolation, the limiting distance of the theme message of chat invitation 15 may be set to, for example, within 100 or 200 meters or within the range between 0.5 and 5 kilometers. Only the potential participant terminals 20, 23 within the specific limiting distance may receive the theme message of chat invitation 15. Thereby, the purpose of the initiator terminal 10 may be achieved conveniently.

Furthermore, in some special circumstances, the user on initiator terminal 10 might not be willing to chat with those too close to his location. For example, he is not willing to discuss some topics with his family, or he does not want his friends to find he is chatting with strangers. In this case, the initiator terminal 10 may set the limiting distance. According to the limiting distance and by setting his location as the center, the user on initiator terminal 10 may instead send the theme message of chat invitation 15 to the potential participant terminals beyond the limiting distance. For example, by setting the limiting distance as 100 or 500 meters, the potential participant terminals 20, 23 with 100 or 500 meters from of the location of the initiator terminal 10 may be excluded for receiving the theme message of chat invitation 15 and thus achieving the purpose of protecting privacy for the initiator terminal 10.

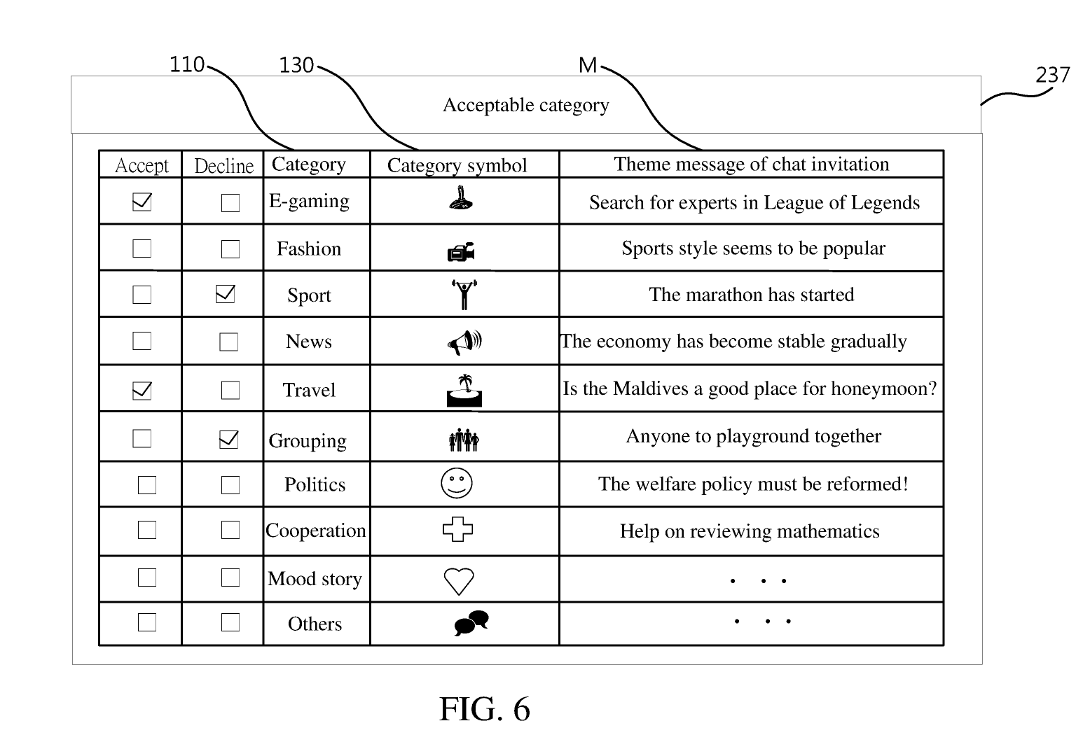

Please refer to FIG. 5, which shows a diagram of the positioning page of a potential participant terminal according to an exemplary embodiment of the present invention. Like the description for FIG. 4, the potential participant terminal 23 according to the present invention may work with the GPS system to position the location of the potential participant terminal 23. In addition, the potential participant terminal 23 may set a limiting distance for setting the range for receiving the theme messages of chat invitation. As shown in the positioning page 235 of the potential participant terminal 23, according to the limiting distance and by setting his location as the center, the potential participant terminal 23 may receive the theme messages of chat invitation 15, 17 sent by the initiator terminals 10, 12 within the limiting distance but not those sent by the initiator terminals beyond the limiting distance. Alternatively, according to the limiting distance and by setting his location as the center, the potential participant terminal 23 may receive the theme messages of chat invitation sent by the initiator terminals beyond the limiting distance only.

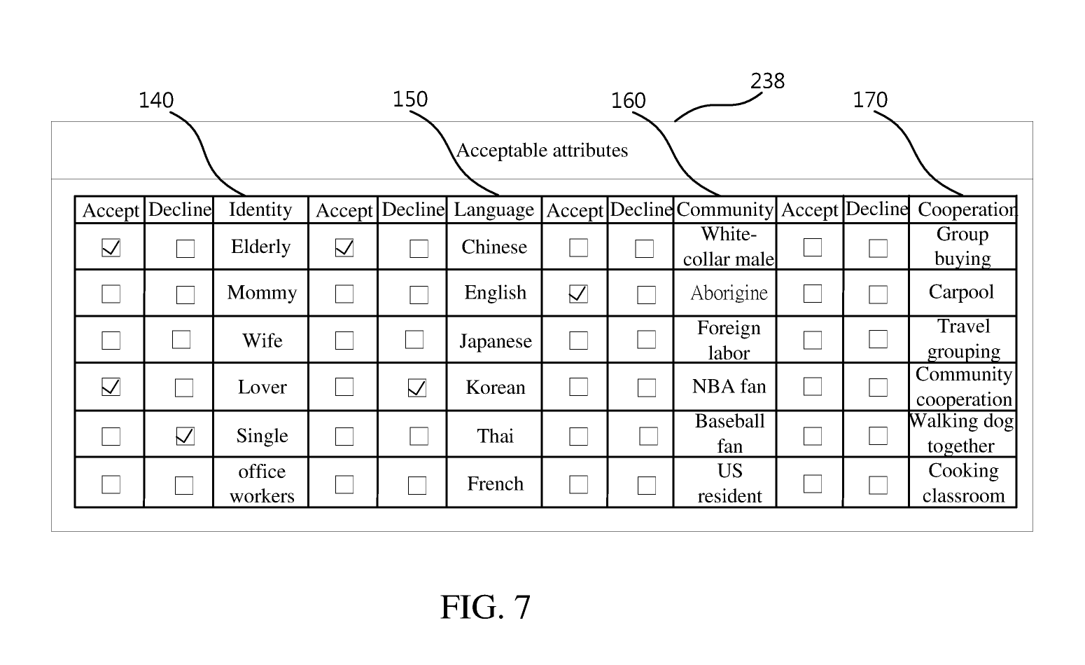

Please refer FIG. 6, which shows a diagram of the category setting page of a potential participant terminal according to an exemplary embodiment of the present invention. As shown in the figure, the potential participant terminal 23 (as shown in FIG. 2) has a category setting page 237 used for presetting at least one acceptable category, which represents at least one category 110 of theme message of chat invitation acceptable by the potential participant terminal 23. The potential participant terminal 23 will receive theme messages of chat invitation according to the acceptable category. The category 110 roughly includes the interest category, the subject category, or the help category. As shown in FIG. 6, the settable categories 110 include e-gaming, fashion, sports, news, travel, grouping, politics, mood story, cooperation, and others. The above examples for the categories 110 are just an exemplary embodiment of the present invention; they may be added or removed according to practical requirements.

In addition, the potential participant terminal 23 may preset at least one declining category, which is just a filtering category. The filtering category represents at least one category of theme message of chat invitation which the potential participant terminal 23 is not willing to receive. Thereby, the user may set at least one acceptable category in the category setting page 237 of the potential participant terminal according to at least one interested category. Then the potential participant terminal 23 may receive the theme message of chat invitation in which the user is interested. Besides, the user may also set at least one declining category in the category setting page 237 of the potential participant terminal 23. Hence, the potential participant terminal 23 will not receive the theme message of chat invitation in which the user is not interested.

In the above description, the at least one acceptable category and at least one filtering category set by the potential participant terminal 23 are recorded in the host 30, as shown in FIG. 2. In addition, when the initiator terminals 10, 12 (as shown in FIG. 2) create theme messages of chat invitation, they may set the category of the theme messages of chat invitation according to the content of the theme messages of chat invitation. When the host 30 receives the theme messages of chat invitation sent by the initiator terminals 10, 12, it recognizes the category of the theme messages of chat invitation. Thereby, the host 30 may filter the theme messages of chat invitation sent by the initiator terminals 10, 12 according to the at least one acceptable category set by the potential participant terminal 23. Then host 30 sends the filtered theme messages of chat invitation to the potential participant terminal 23. For example, as shown in FIG. 6, the potential participant terminal 23 sets the acceptable categories are e-gaming and travel. If the category of the theme message of chat invitation 15 created by the initiator terminal 10 is travel and the category of the theme message of chat invitation 17 created by the initiator terminal 12 is e-gaming, then the host 30 will send the theme messages of chat invitation 15, 17 to the potential participant terminal 23.

Moreover, the host 30 further filters the theme messages of chat invitation sent by the initiator terminals 10, 12 according to the at least one filtering category set by the potential participant terminal 23, and sends the filtered theme messages of chat invitation to the potential participant terminal 23. For example, as shown in FIG. 6, the potential participant terminal 23 sets the filtering categories to include sports and grouping. If the category of the theme message of chat invitation created by the initiator terminal 10 is travel and the category of the theme message of chat invitation 17 created by the initiator terminal 12 is sports, then the host 30 will filter out the theme message of chat invitation 17 created by the initiator terminal 12 and send the theme message of chat invitation 15 created by the initiator terminal 10 to the potential participant terminal 23 only. According to the above description, it is known that by using the above method, the theme messages of chat invitation having specific categories may be sent to the potential participant terminals willing to accept the specific categories. Then the initiator terminals and the potential participant terminals having some common points may be matched and form an interactive group. In the above description, the potential participant terminals 23 are used for description. The above method also applies to the other potential participant terminals 20, 25 and they may form interactive groups with the initiator terminals 10, 12 as well.

In addition, the category setting page 237 shown in FIG. 6 further includes category symbols 130 and theme message of chat invitation examples M. The category symbols 130 correspond to the various categories 110 of the theme messages of chat invitation. As the theme messages of chat invitation are sent to the potential participant terminals 20, 23, 25, initially, the message display region 232 of the message page 231 (as shown in FIG. 3) will display the plurality of symbols 151, 171 only but not the contents of the plurality of theme messages of chat invitation. The contents of the plurality of theme messages of chat invitation will not be displayed in the message display region 232 of the message page 231 until the user checks the accept blocks for the plurality of symbols 151, 171. Besides, according to the theme messages of chat invitation examples M, the theme message of chat invitation may be a subject (for example, “The welfare policy must be reformed!”), a share message (for example, “The marathon has started”, an opinion (for example, “The economy has become stable gradually”), an inquiry (for example, “Is the Maldives a good place for honeymoon?”), or a demand (for example, “Help on reviewing mathematics”).

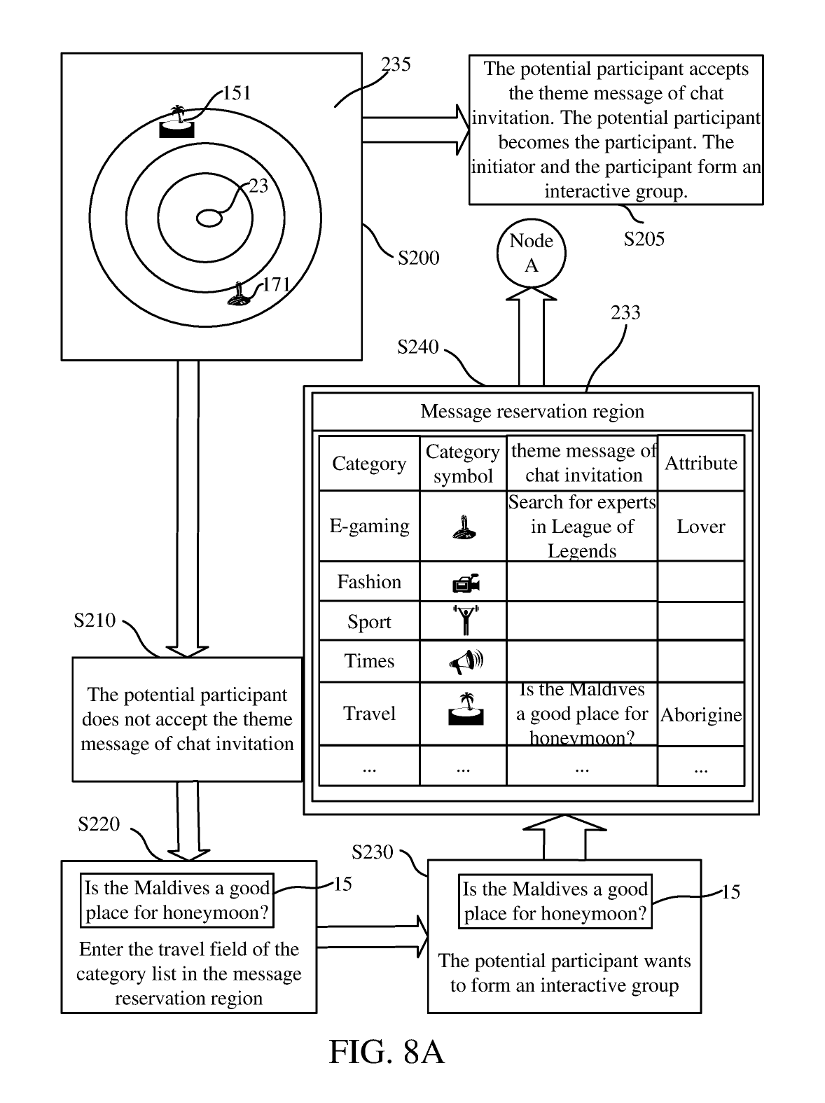

Please refer to FIG. 7, which shows a diagram of the attribute setting page of a potential participant terminal according to an exemplary embodiment of the present invention. Each potential participant terminal has an attribute setting page. In FIG. 7 and the following description, the attribute setting page 238 of the potential participant terminal 23 (as shown in FIG. 2) is taken for example. The attribute setting page 238 is used for presetting at least one acceptable attribute, which represents the attribute types of the initiator terminal acceptable by the potential participant terminal 23 and used as the judgment determining whether the potential participant terminal 23 is willing to accept the invitation by the initiator terminal.

As shown in FIG. 7, the settable attributes could include identity attributes 140, language attributes 150, community attributes 160, and cooperation attributes 170. The identity attributes 140 could include the elderly, mommy, wife, lover, single, and office worker. The language attributes 150 could include Chinese, English, Japanese, Korean, Thai, and French. The community attributes 160 could include white-collar male, aborigine, foreign labor, NBA fan, baseball fan, and US resident. The cooperation attributes 170 could include group buying, carpool, travel grouping, community resident cooperation, walking the dog together, and cooking classroom. The above attribute types are just an exemplary embodiment of the present invention; and they may be added or removed according to requirements. Besides, when each initiator terminal and each potential participant terminal log in the host 30 (as shown in FIG. 2), personal attributes similar to the attribute setting page 238 shown in FIG. 7 must be set first for setting the attributes of the initiator terminal and the potential participant terminal. The acceptable attributes and personal attributes set by each potential participant terminal as described above, and the personal attributes set by the initiator terminal will be recorded in the host 30.

In the following, an example will be provided for description. The personal attribute of the initiator terminal 10 is the elderly; the personal attribute of the initiator terminal 12 is aborigine. As shown in FIG. 7, the acceptable attributes set by the potential participant terminal 23 are the elderly, lover, Chinese, aborigine, meaning that the personal attributes of the initiator terminals 10, 12 match one of the above acceptable attributes. That's why the potential participant terminal 23 receives the theme messages of chat invitation 15, 17 sent by the initiator terminals 10, 12, as shown in FIG. 2. The detailed execution method is that the host 30 filters the initiator terminals 10, 12 according to the acceptable attributes of the potential participant terminal 23. Because the personal attributes of the initiator terminals 10, 12 both match one of the acceptable attributes, the host 30 sends the theme messages of chat invitation 15, 17 of the initiator terminals 10, 12 to the potential participant terminal 23.

Moreover, according another exemplary embodiment of the present invention, after the host 30 filters the initiator terminals 10, 12 according to the acceptable attributes of the potential participant terminal, if the personal attributes of the initiator terminals 10, 12 both match one of the acceptable attributes of the potential participant terminal 23, the host 30 further filters the theme messages of chat invitation 15, 17 created by the initiator terminals 10, 12 according to the acceptable categories of the potential participant terminal 23. If the categories of the theme messages of chat invitation 15, 17 created by the initiator terminals 10, 12 matches one of the acceptable categories of the potential participant terminal 23, the host 30 sends the theme messages of chat invitation 15, 17 to the potential participant terminal 23.

Furthermore, the potential participant terminal 23 may also preset at least one excluding attribute, which is just a filtering attribute. The filtering attribute represents at least one attribute type of theme message of chat invitation which the potential participant terminal 23 is not willing to receive. For example, if the excluding attribute of the potential participant terminal 23 is single and the personal attribute of the initiator terminal 12 is single, then the host 30 will not send the theme message of chat invitation 17 of the initiator terminal 12 to the potential participant terminal 23. According to the above description, the user may set at least one acceptable attribute in the attribute setting page 238 of the potential participant terminal according to personal preference. Thereby, the potential participant terminal may receive the theme messages of chat invitation matching the user's preference. In addition, the user may also set at least one excluding attribute in the attribute setting page 238 of the potential participant terminal. Hence, the potential participant terminal will not receive the theme messages of chat invitation of the initiator terminals not matching the user's preference.

By setting acceptable and excluding identity attributes 140, it is convenient for initiator terminals and potential participant terminals to find chat targets having the same background, which facilitates smooth development of chatting or friending given the understanding. By setting acceptable and excluding language attributes 150, it is convenient for initiator terminals and potential participant terminals to find mates capable of communicating in the same language from different cities or specific areas. Even one is traveling abroad, the function helps in finding friendly local friends or travel mates of the same nationality capable of speaking the same language. By setting acceptable and excluding community attributes 160, it is convenient for initiator terminals and potential participant terminals to find partners having the same community identity, which may facilitate enhancing senses of identity and belonging among the chat participant terminals. By setting acceptable and excluding cooperation attributes 170, it is convenient for initiator terminals and potential participant terminals to return physical world from the virtual interactions on the network. By using the method according to the present invention, the initiator terminals and potential participant terminals having common interests and recognition are connected. Furthermore, the method according to the present invention may be applied to various types of cooperation and thus connecting neighboring people. Hence, the present invention is location oriented.

In the following exemplary embodiment, the method for initiating real-time interactive groups will be described. After the potential participant terminal 23 (as shown in FIG. 2) receives multiple theme messages of chat invitation 15, 17, the theme messages of chat invitation may be displayed in a specific order or randomly on the message page 231 of the potential participant terminal 23 (as shown in FIG. 3). Alternatively, the symbols 151, 171 of the theme messages of chat invitation 15, 17 may be displayed on the positioning page 235 of the potential participant terminal 23 in a radar-like coordinates by using the potential participant terminal 23 as the center (as shown in FIG. 5).

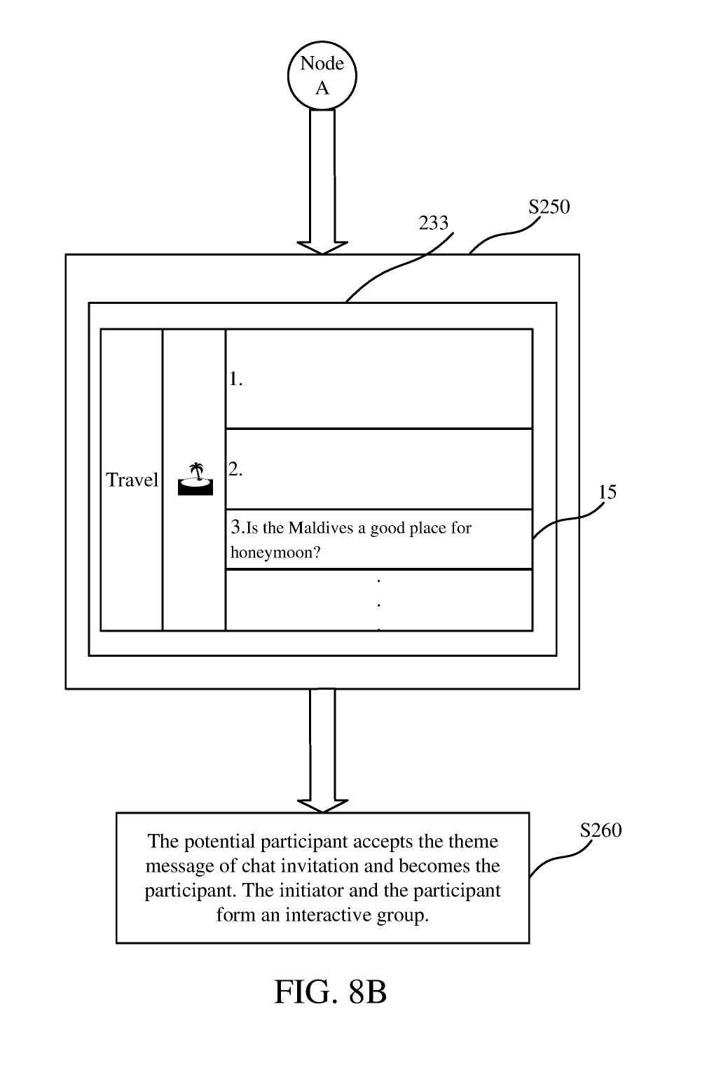

In the following exemplary embodiment, the positioning page 235 shown in FIG. 8A is taken as an example for description. The positioning page 235 displays multiple symbols 151, 171, which represent multiple theme messages of chat invitation 15, 17. By clicking the plurality of symbols 151, 171, the contents of the plurality of theme message of chat invitation 15, 17 will be displayed. The plurality of symbols 151, 171 will be kept on the positioning page 235 for a period, for example, 3 to 8 seconds. If the potential participant terminal 23 does not accept the theme message of chat invitation 15, 17 and an interactive group is not formed, the plurality of theme messages of chat invitation 15, 17 will be kept in the message reservation region 233 of the message page 231 according to the defined categories, as shown in FIG. 3. Then the message reservation region 233 will display the categories and the personal attributes of the initiator terminals 10, 12 that created the theme messages of chat invitation 15, 17, so that the potential participant terminal 23 may form an interactive group with the initiator terminals 10, 12.

For example, as shown in the step S200, the potential participant terminal 23 receives multiple theme messages of chat invitation 15, 17. The theme message of chat invitation 15 corresponding to the symbol 151 is an inquiry in the travel category: “Is the Maldives a good place for honeymoon?” Once the symbol 151 is selected, the message “Is the Maldives a good place for honeymoon?” will be displayed on the positioning page 235. If the potential participant terminal 23 is willing to accept the theme message of chat invitation 15, as shown in the step S205, as the theme message of chat invitation 15 is displayed on the positioning page 235, he may accept the theme message of chat invitation 15 directly and hence forming an interactive group smoothly.

As shown in the step S210, if the theme message of chat invitation 15 is displayed on the positioning page 235 and the potential participant terminal 23 does not accept the theme message of chat invitation 15, as shown in the step S220, no matter the potential participant terminal 23 is still interested in the theme message of chat invitation 15 for forming an interactive group, this theme message of chat invitation will be listed in the travel category according to its category. Afterwards, as shown in the step S230, if the potential participant terminal 23 is still interested in the theme message of chat invitation 15 and wants to form an interactive group, then as shown in the step S240, the potential participant terminal 23 may find the travel category in the message reservation region 233. Next, as shown in the step S250 (as shown in FIG. 8B), he may find the theme message of chat invitation 15 in the travel category. For example, there are 10 theme messages of chat invitation in the travel category. The potential participant terminal 23 finds the theme message of chat invitation “Is the Maldives a good place for a honeymoon?” from the 10 theme messages of chat invitation an executes the step S260 (as shown in FIG. 8B) for forming an interactive group.

As described above, the potential participant terminal 23 has to set multiple acceptable categories, such as e-gaming, sports, and travel, and multiple acceptable attributes, such as identity, language, and community. Thereby, the potential participant terminal 23 may receive theme messages of chat invitation in different categories sent by initiator terminals having different attributes concurrently. In addition, multiple theme messages of chat invitation in different categories from initiator terminals having different attributes may be displayed on the message page 231 (as shown in FIG. 3) and the positioning page 235 (as shown in FIG. 5) of the potential participant terminal 23. The theme message of chat invitation in different categories may be represented by different symbols and displayed on the message page 231. In addition, the message page 231 and the positioning page 235 of the potential participant terminal 23 may be set to display the theme messages of chat invitation in a single category or more. Thus, although the potential participant terminal 23 receives the theme messages of chat invitation in different categories, the potential participant terminal 23 shows the theme messages of chat invitation in the specific category or more. For example, the message page 231 and the positioning page 235 of the potential participant terminal 23 both shows the symbols 151(referred to traveling) and 171 (referred to e-gaming), however, the potential participant terminal 23 may be set to shade the symbols 171. Only the symbol 151 may be shown on the message page 231 and the positioning page 235 of the potential participant terminal 23. Also, the symbols 151 is corresponding to the theme messages of chat invitation in the travel category.

The attributes as described above, including identity attribute, language attribute, and community attribute, may be changed or updated according to the requirements by a specific time, place, local culture, fashion, or news. Besides, these attributes may be adjusted or customized for personal or group demands.

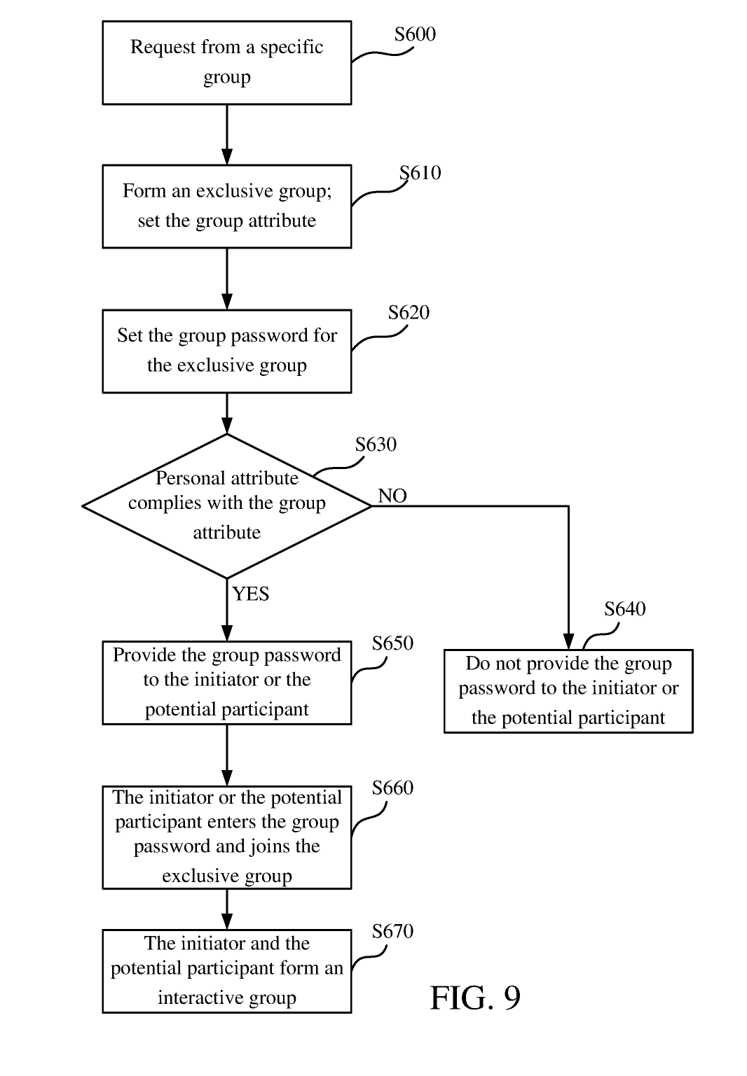

Please refer to FIG. 9, which shows a flowchart of initiating exclusive interactive groups according to an exemplary embodiment of the present invention. Initially, as shown in the step S600, an exclusive group is formed for a specific group, for example, the University of Michigan. Only the members of the University of Michigan may join the exclusive group and form interactive groups, for example, a friending and social group, in the exclusive group. Next, the step S610 is executed. The host 30, as shown in FIG. 2, forms an exclusive group, such as an exclusive group for the University of Michigan, and sets the group attributes of the exclusive group. For example, the identity attributes include the staff, the student, and the alumnus of the University of Michigan.

Next, as shown in the step S620, the host 30 presets a group password corresponding to the exclusive group. Then, as shown in the step S630, the host 30 judges, if the personal attribute of a user (the initiator terminal or the potential participant terminal) logged on the host 30, corresponds to the group attribute. If not, it means that the user is not a member of the University of Michigan. Then, as shown in the step S640, the host 30 does not provide the group password to the user (the initiator terminal or the potential participant terminal). According to the present embodiment, in the setting page for the personal attribute of the initiator terminal or the potential participant terminal, the options for the identity attribute include the staff, the student, and the alumnus of the University of Michigan.

When the host 30 judges that the personal attribute of a user (the initiator terminal or the potential participant terminal) logged on the host 30 corresponds to the group attribute, as shown in the step S650, the host 30 provides the group password to the user. Thereby, as shown in the step S660, the user may select the exclusive group created by the host 30 and enter the group password. Then the user may join the exclusive group. Accordingly, as shown in the step S670, the users joining the exclusive group, namely, the initiator terminal and the potential participant terminals, may form interactive groups according to the method as described above. Because this specific attribute is limited to the members of the University of Michigan, by applying the method according to the present invention, the male and female members of the University of Michigan may limit the scope of searching for a chat. According to the selected or excluded categories set by the users, interactive groups may be formed for chat targets having common points. Likewise, the method according to the present invention may be applied to some specific department, grade, or society in a university, and becomes a useful tool for searching suitable chat targets or forming interactive groups. Besides, the group attributes described above may include identity, language, or community attributes.

Furthermore, after the initiator terminal and the potential participant terminals form an interactive group, the default administrator of the interactive group is the initiator terminal. In addition, it is set to default that the initiator terminal may give up or reject to be the administrator. Instead, a potential participant terminal may be assigned to be the administrator.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for spontaneously initiating real-time interactive groups on the network, executed on a host, and comprising:
at least one initiator terminal sending a theme message of chat invitation;
sending said theme message of chat invitation to at least one potential participant terminal; and
said at least one potential participant terminal accepting said theme message of chat invitation to become at least one participant terminal, and to form an interactive group;
wherein said interactive group includes said at least one initiator terminal and said at least one participant terminal.

2. The method of claim 1, wherein said at least one initiator terminal includes a plurality of initiator terminals, and said at least one potential participant terminal receives said plurality of theme messages of chat invitation sent by said plurality of initiator terminals concurrently.

3. The method of claim 2, wherein said theme message of chat invitation is a non-text message including embedded live streams, video clips, or photos.

4. The method of claim 2, wherein said theme message of chat invitation is a subject, a shared message, an opinion, an inquiry, or a demand.

5. The method of claim 2, wherein said plurality of theme messages of chat invitation received by said at least one potential participant terminal are arranged in a specific order or randomly and displayed on a message page of said at least one potential participant terminal concurrently or sequentially.

6. The method of claim 5, wherein said theme message of chat invitation is a non-text message including embedded live streams, video clips, or photos.

7. The method of claim 5, wherein said theme message of chat invitation is a subject, a shared message, an opinion, an inquiry, or a demand.

8. The method of claim 5, further comprising:
reserving said plurality of theme messages of chat invitation in a message reservation region after said plurality of theme messages of chat invitation are displayed on said message page of said at least one potential participant terminal for a display time.

9. The method of claim 8, wherein said theme message of chat invitation is a non-text message including embedded live streams, video clips, or photos.

10. The method of claim 8, wherein said theme message of chat invitation is a subject, a shared message, an opinion, an inquiry, or a demand.

11. The method of claim 1, further comprising:
representing said theme message of chat invitation using a symbol;
displaying said symbol on a message page of said at least one potential participant terminal; and
displaying the content of said theme message of chat invitation on said message page of said at least one potential participant terminal as symbol is selected.

12. The method of claim 1, further comprising:
positioning the location of said at least one initiator terminal; and
according to a limiting distance and by using the location of said at least one initiator terminal as the center, sending said theme message of chat invitation to said at least one potential participant terminal within or beyond said limiting distance.

13. The method of claim 1, further comprising:
presetting at least one acceptable category representing at least one category of said theme message of chat invitation acceptable by said at least one potential participant terminal;
said host filtering said theme message of chat invitation sent by said at least one initiator terminal according to said at least one acceptable category; and
said host sending said filtered theme message of chat invitation to said at least one potential participant terminal.

14. The method of claim 13, wherein said at least one initiator terminal sets the category of said theme message of chat invitation according to the content of said theme message of chat invitation, and said host filters said theme message of chat invitation sent by said at least one initiator terminals according to the category of said theme message of chat invitation and said at least one acceptable category.

15. The method of claim 14, wherein the category of said theme message of cat invitation includes interest category, subject category, or cooperation category.

16. The method of claim 13, further comprising:
presetting a personal attribute of said at least one initiator terminal;
presetting at least one acceptable attribute of said at least one potential participant terminal;
said host filtering said at least one initiator terminal according to said at least one acceptable attribute;
when said personal attribute of said at least one initiator terminal corresponds to said at least one acceptable attribute, said host further filtering said theme message of chat invitation sent by said at least one initiator terminal having personal attribute corresponding to said acceptable attribute;
said host sending said filtered theme message of chat invitation to said at least one potential participant terminal; and
said at least one acceptable attribute including identity, language, or community.

17. The method of claim 1, further comprising:
presetting at least one filtering category representing at least one category of said theme message of chat invitation unacceptable by said at least one potential participant terminal;
said host filtering said theme message of chat invitation sent by said at least one initiator terminal according to said at least one filtering category; and
said host sending said filtered theme message of chat invitation to said at least one potential participant terminal.

18. The method of claim 1, further comprising:
presetting a personal attribute of said at least one initiator terminal;
presetting at least one acceptable attribute of said at least one potential participant terminal;
said host filtering said at least one initiator terminal according to said at least one acceptable attribute; and
when said personal attribute of said at least one initiator terminal corresponds to said at least one acceptable attribute, said host sending said theme message of chat invitation of said at least one initiator terminal having personal attribute corresponding to said acceptable attribute to said at least one potential participant terminal.

19. The method of claim 1, further comprising:
presetting a group attribute of an exclusive group; presetting a group password corresponding to said exclusive group;
when a personal attribute of said at least one initiator terminal corresponds to said group attribute, providing said group password to said at least one initiator terminal;
said at least one initiator terminal joining said exclusive group according to said group password;
when a personal attribute of said at least one potential participant terminal corresponds to said group attribute, providing said group password to said at least one potential participant terminal; and
said at least one potential participant terminal joining said exclusive group according to said group password; and said group attribute including identity, language, or community.

20. The method of claim 1, wherein said theme message of chat invitation is a subject, a share message, an opinion, an inquiry, or a demand, or a non-text message including embedded live streams, video clips, or photos.
